(19) United States
(12) Patent Application Publication
(10) Pub. No.: US 2009/0327876 A1
(43) Pub. Date: Dec. 31, 2009

(54) User interface framework with embedded text formatting

(75) Inventors: Jevan D. Saks, Redmond, WA (US); Christopher A. Glein, Seattle, WA (US); Stefan C. Negritoiu, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/146,046

(22) Filed: Jun. 25, 2008

(51) Int. Cl. G06F 17/21

(52) U.S. Cl. 715/256

(57) ABSTRACT

Various embodiments provide a user interface (UI) framework that implements techniques and processes for tagging text in a markup document and designating one or more custom text effects to be applied to the tagged text. Some embodiments provide an integrated application programming interface (API) that implements a common programming model for specifying UI elements and applying a wide variety of text effects to text content in a UI. Certain example embodiments enable a section of text to be identified and one or more custom effects for the text to be specified in line with the section of text. The UI framework may provide one or more pre-coded effects and/or a user may create one or more custom effects to be applied to the section of text.

### BACKGROUND

A typical user interface (UI) includes a variety of different content, such as text, graphics, multimedia content, and so on. A common example of a user interface is a Web page. The visual content of a Web page is typically managed by a Web browser's layout engine. Frameworks for most UIs, however, provide a limited number of effects that may be applied to text content, such as underlining, bolding, italicizing, and so on. To apply text effects beyond those commonly available in a typical UI framework, a Web browser often has to implement a rendering engine separate from the layout engine in order to process text as it would any other image content. Thus, text content may lose some or all of its text character, and accordingly, some functionality that often accompanies the ability to treat “text as text”.

In addition, several challenges may arise when text is processed by a separate rendering engine and treated as image content. First, multiple programming models may be utilized by the separate layout engine and rendering engine, thus forcing a user to learn multiple programming models and/or protocols. Second, when applying effects to text content, a user may be prevented from taking advantage of bitmap and other effects offered by a UI framework in its primary rendering engine, since text is typically not treated as a primary visualization in the main rendering pipeline. Third, because user input is often handled by the main rendering engine of a UI framework, the ability to respond to user interaction with individual text fragments may be limited.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a user interface (UI) engine that implements techniques and processes for tagging text in a markup document and designating one or more custom text effects to be applied to the tagged text. Some embodiments provide an integrated application programming interface (API) that implements a common programming model for specifying UI elements and applying a wide variety of text effects to text content in a UI. Certain example embodiments enable a section of text to be identified and one or more custom effects for the text to be specified in line with the section of text. The UI engine may provide one or more pre-coded effects and/or a user may create one or more custom effects to be applied to the section of text.

### BRIEF DESCRIPTION OF THE DRAWINGS

The same numbers are used throughout the drawings to reference like features.

FIG. 1 illustrates one example of an operating environment in which various principles and techniques described herein for applying text effects can be employed in accordance with one or more embodiments.

FIG. 2 is a flow diagram of one example process for identifying text and applying effects to the text utilizing techniques discussed herein, according to one or more embodiments.

FIG. 3 is a control tree that illustrates a logic flow for utilizing techniques discussed herein to identify text and apply text effects to the text, according to one or more embodiments.

FIG. 4 illustrates one implementation example of text that is processed using techniques discussed herein, according to one or more embodiments.

### DETAILED DESCRIPTION

### Overview

Various embodiments provide a user interface (UI) framework that integrates text content and other UI elements into a consistent programming model. The framework enables a wide variety of text formatting options to be embedded with text content and provides a diverse palette of text effects beyond those currently available. In some embodiments, a user may implement the framework to identify a section of text (hereinafter a “text run”) and apply a graphical effect to the text run without the need to export the text run to an external rendering engine and/or convert the text run to a different format. Examples of graphical effects that may be applied to text (“text effects”) include text blurring, text animation, text rotation, bitmap effects, and so on. A user that implements the framework may choose a preexisting text effect to apply to a text run, or may code a custom text effect to apply to the text run.

The UI framework allows effects to be applied to a text run while treating the “text as text”. Thus, while the framework provides a way to apply a wide variety of text effects to a text run, the processed text run retains its text character and may be formatted, reflowed, and otherwise treated as standard text. A processed text run may also be copied, cut, and/or pasted to other documents and/or applications to provide data and/or content. To implement the framework, certain embodiments treat a text run as a primary element of the visualization primitives of a UI, thus allowing the text run to be manipulated as a primary element.

In the discussion that follows, a section entitled “Operating Environment” is provided and describes an environment in which one or more embodiments can be employed. Following this, a section entitled “Example Process” is provided that describes one example of a process that can implement techniques discussed herein, according to one or more example embodiments. Finally, a section entitled “Implementation Examples” is provided that discusses details for example implementations of techniques and processes discussed herein, according to one or more embodiments.

### Operating Environment

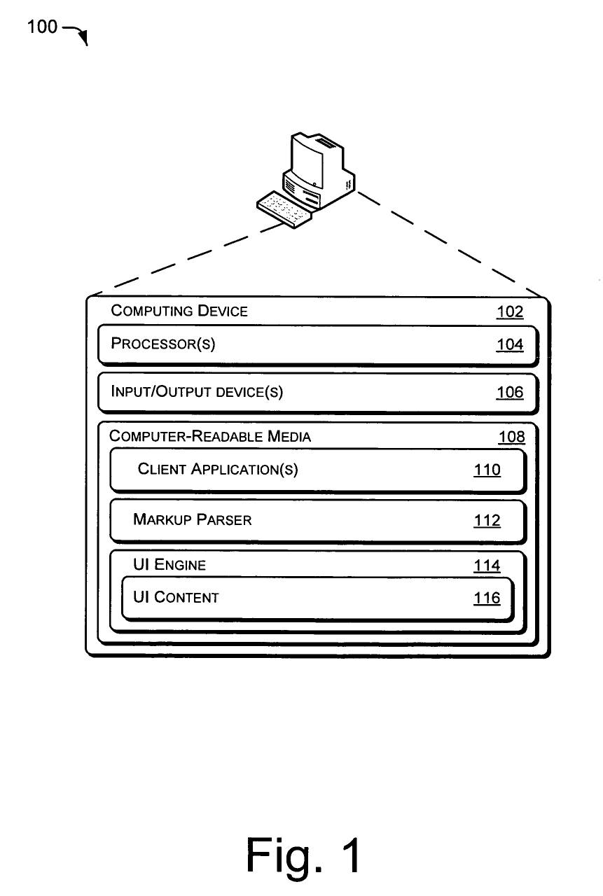

FIG. 1 illustrates generally at 100 one example of an operating environment that is operable to employ one or more aspects of the UI framework, in accordance with one or more embodiments. Environment 100 includes a computing device 102 having one or more processors 104, one or more input/output devices 106, and one or more computer-readable media 108. The computing device 102 can be embodied as any suitable computing device such as, by way of example and not limitation, a desktop computer, a portable computer, or a handheld computer such as a personal digital assistant (PDA), a mobile media device, a cell phone, and the like. The computing device 102 is configured such that it can interface with one or more networks (not shown), such as a local area network, a wide area network, the Internet, the World Wide Web, and so on. The input/output devices 106 may include any suitable device for providing input to the computing device (e.g., a keyboard, a mouse, a touch pad, and so on) and any suitable device for providing output from the computing device (e.g., a monitor or other graphical display, audio speakers, and so on).

Stored on the computer-readable media 108 are one or more client applications 110, a markup parser 112, and a UI engine 114. Examples of client applications include a web development application, a web browser, a media rendering application, and so on. The markup parser 112 processes markup code (e.g., HTML, XML, and/or any other suitable markup language) and converts the markup into a form that can be utilized by the UI engine. The UI engine is configured to implement the UI framework discussed above, as well as various other techniques and processes discussed herein. In some embodiments, the UI engine comprises an application programming interface (API) that implements one or more aspects of the techniques and processes discussed herein. The UI engine 114 includes UI content 116, which may include various UI elements (e.g., graphics, text, and so on) that may be utilized to generate a UI.

### Example Process

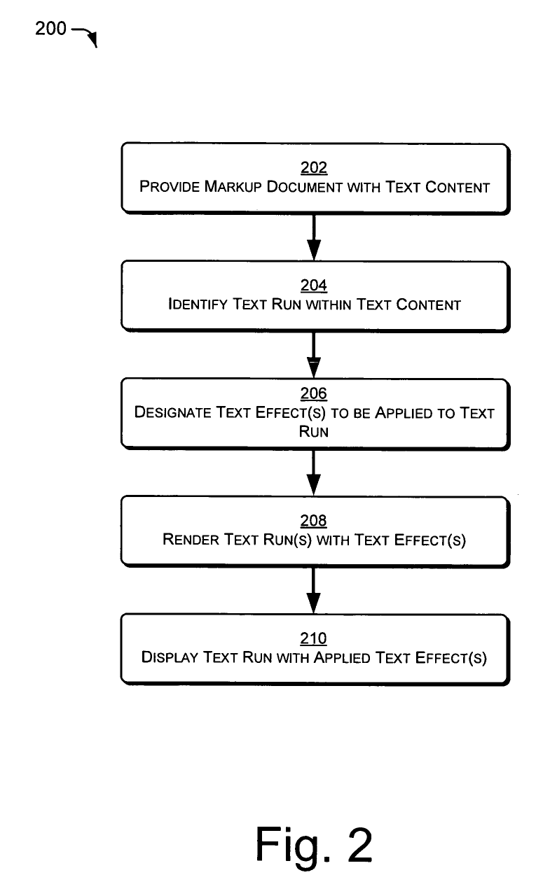

FIG. 2 illustrates one example of a process 200 that implements aspects of the principles and techniques discussed herein, according to one or more embodiments. The processes and techniques discussed herein can be implemented in connection with any suitable hardware, software, firmware, or combination thereof.

Block 202 provides a markup document that comprises text content. Block 204 identifies one or more text runs within the text content that are to be processed with one or more graphical text effects. A text run may be identified using a variety of different methods. In one example embodiment, a text run is identified with a particular markup tag that designates the text run as text that is to receive particular processing, such as a text effect. Block 206 designates one or more text effects that are to be applied to the text run(s). Block 208 render(s) the text run(s) with the designated text effect(s), and block 210 displays the text run(s) with the text effect(s) applied.

In some embodiments, one or more acts of process 200 may occur in response to certain events. For example, a text run may be rendered with one or more text effects in response to a markup document being loaded by an application, such as a Web browser. Additionally and/or alternatively, a text run may be rendered in response to a user interaction with the text run, such as selecting the text run with a mouse and cursor, clicking on the text run, hovering a cursor over the text run, and so on. While not illustrated here, some embodiments reflow text content that surrounds the rendered text runs to account for one or more changes to the text run(s).

In some embodiments, process 200 occurs within a single block of markup (i.e., the text run is identified and the text effects are applied within a single block of code). Process 200 may also be implemented by a single integrated API that enables a user to specify one or more text runs, and designate and apply one or more text effects to the text run(s) using the API.

### Implementation Examples

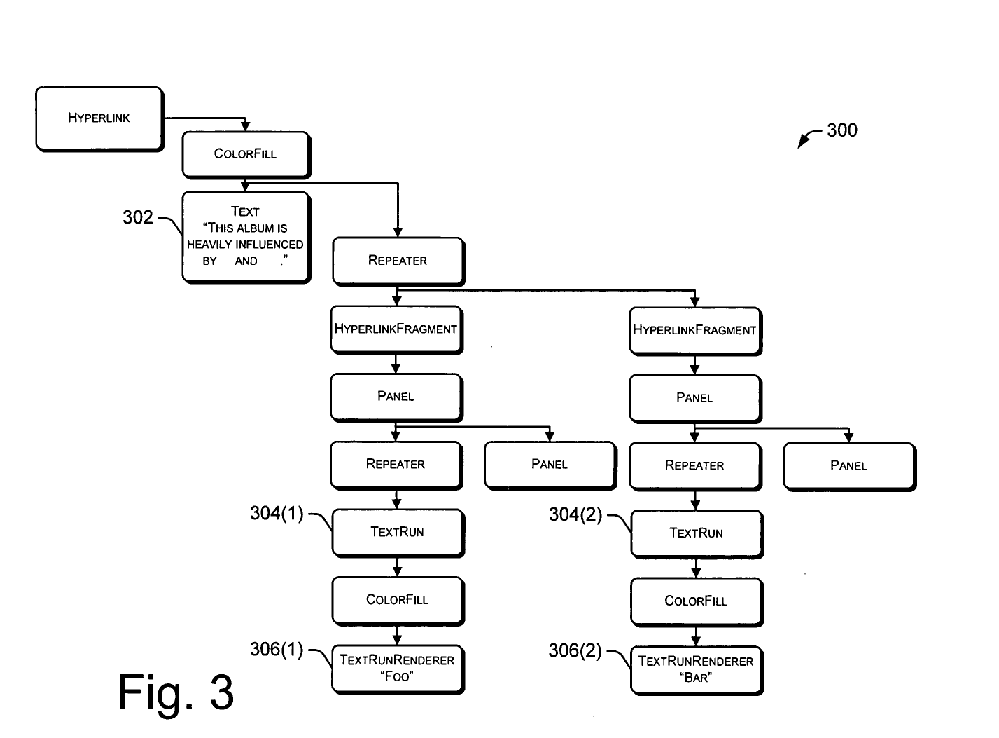

FIG. 3 illustrates at 300 one example of a UI control tree for a section of markup that specifies text content and applies one or more text effects to text runs within the text content. A partial example of a markup code representation that corresponds to the control tree 300 is presented below:

```
<me:Hyperlink>
  <Content>
  <![CDATA[This album is heavily influenced by <Artist>Foo</Artist>
and <Artist>Bar</Artist>.]]>
  </Content>
</me:Hyperlink>
```

The content data provided above includes two text runs that are identified with the <Artist> tag: “Foo” and “Bar”. Block 302 illustrates the text content with the identified text runs removed to indicate that one or more text effects will be applied to the text runs. Block 304(1) indicates that “Foo” has been designated as a text run, and block 304(2) indicates that “Bar” has been designated as a text run. Blocks 306(1) and 306(2) indicate that the text runs are to be rendered with one or more designated text effects.

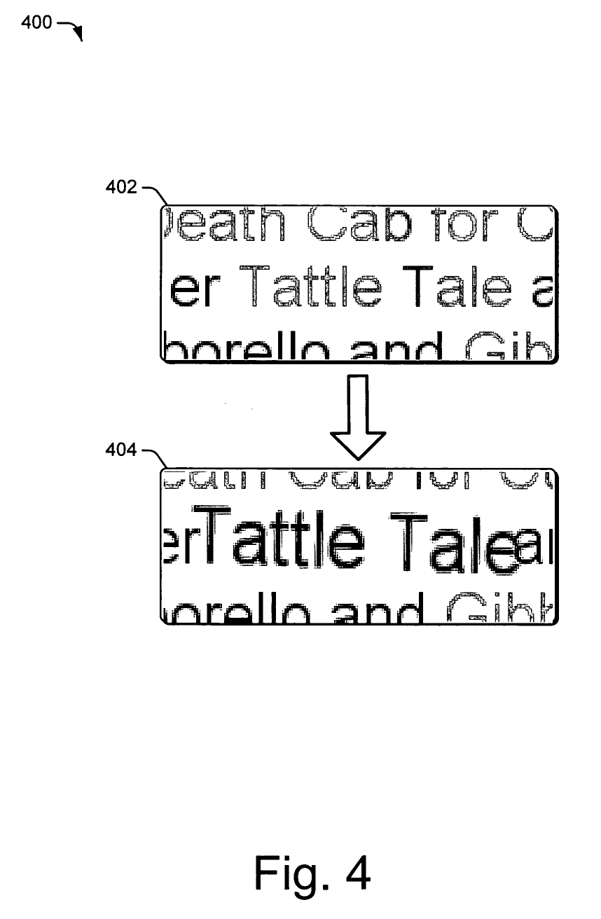

FIG. 4 illustrates at 400 one example of a text run processed with one or more text effects, according to one or more example embodiments. Block 402 illustrates a text run (“Tattle Tale”) that a user has selected for receiving one or more text effects. Block 404 illustrates the text run after one or more text effects have been applied. As illustrated, the text run has increased in size and has rotated around the z-axis. In some embodiments, the text effects are applied in response to certain input, such as when a user selects the text or hovers a cursor over the text.

The following is one example of markup code that may be implemented to achieve the particular text effects illustrated in block 404. Following the code, particular aspects of the code are discussed.

```
<UIX
  xmlns=“http://schemas.acme.com/2007/uix”
  xmlns:code=“assembly://UIX/Acme.Iris”
  xmlns:me=“Me”
  xmlns:sys=“assembly://accorlib/System”>
  <UI Name=“Default”>
  <Content>
    <ColorFill Content=“White” Layout=“VerticalFlow”>
    <Children>
      <me:Hyperlink Visible=“True”>
      <Content>
        <![CDATA[Named for the way they traded sounds and ideas, the
Postal Service is an electronica-meets-indie rock supergroup featuring
Jimmy Tamborello (of <Artist ID=“1111”>Dntel</Artist> and <Artist
ID=“1234”>Figurine</Artist>), and <Artist ID=“10”>Death Cab for
Cutie</Artist>'s <Artist ID=“5”>Ben Gibbard</Artist>; <Artist>Rilo
Kiley</Artist>'s <Artist>Jenny Lewis</Artist>, and former <Artist>Tattle
Tale</Artist> and solo artist <Artist>Jen Wood</Artist> provide backing
vocals. Tamborello and <Artist>Gibbard</Artist> first worked together on
the title track of <Artist>Dntel</Artist>'s <Album>This Is The Dream
Of Evan And Chan</Album> EP; from there, the duo continued to
collaborate via mail, with Tamborello sending electronic pieces
and <Artist>Gibbard</Artist> adding guitars, vocals, and lyrics.
The result, <Album>Give Up</Album>,
were released in early 2003 by Sub Pop. ~ Heather Phares, All Music
Guide ]]>
      </Content>
      </me:Hyperlink>
    </Children>
    </ColorFill>
  </Content>
  </UI>
  <UI Name=“Hyperlink”>
  <Properties>
    <sys:String Name=“Content” String=“$Required”/>
    <HorizontalAlignment Name=“HorizontalAlignment”
HorizontalAlignment=“Near”/>
    <sys:Boolean Name=“WordWrap” Boolean=“True”/>
  </Properties>
  <Scripts>
    <Script>HyperlinkRepeater.Source = [Text.Fragments];</Script>
  </Scripts>
  <Content>
    <ColorFill Content=“White”>
    <Children>
      <Text Name=“Text” Color=“Black” Font=“Arial,20”
WordWrap=“{WordWrap}” Content=“{Content}”
HorizontalAlignment=“{HorizontalAlignment}”>
      <NamedStyles>
        <TextStyle Name=“Artist” Color=“Orange” Fragment=“true”/>
        <TextStyle Name=“Album” Color=“Red” Fragment=“true”/>
      </NamedStyles>
      </Text>
      <Repeater Name=“HyperlinkRepeater”>
      <Content>
        <me:HyperlinkFragment
TextFragment=“{(TextFragment)RepeatedItem}”/>
      </Content>
      </Repeater>
    </Children>
    </ColorFill>
  </Content>
  </UI>
  <UI Name=“HyperlinkFragment”>
  <Properties>
    <TextFragment Name=“TextFragment” TextFragment=“$Required”/>
  </Properties>
  <Locals>
    <code:BooleanChoice Name=“FragmentMouseFocus”/>
    <code:BooleanChoice Name=“FragmentKeyFocus”/>
    <code:BooleanChoice Name=“FragmentClicking”/>
  </Locals>
  <Input>
    <ClickHandler Name=“Clicker”/>
  </Input>
  <Scripts>
    <Script>UI.AllowDoubleClicks = false;</Script>
    <Script>FragmentMouseFocus.Value = [UI.MouseFocus];</Script>
    <Script>FragmentKeyFocus.Value = [UI.KeyFocus];</Script>
    <Script>FragmentClicking.Value = [Clicker.Clicking];</Script>
    <Script>TextRunRepeater.Source = TextFragment.Runs;</Script>
  </Scripts>
  <Content>
    <Panel>
    <Children>
      <Repeater Name=“TextRunRepeater”>
      <Content>
        <me:TextRun Name=“TextRun”
Data=“{(TextRunData)RepeatedItem}”
            FragmentMouseFocus=“{FragmentMouseFocus}”
            FragmentKeyFocus=“{FragmentKeyFocus}”
            FragmentClicking=“{FragmentClicking}”
            MouseInteractive=“True”>
        <Margins>
          <Inset Left=“{((TextRunData)RepeatedItem).Position.X}”
Top=“{((TextRunData)RepeatedItem).Position.Y}”/>
        </Margins>
        </me:TextRun>
      </Content>
      </Repeater>
    </Children>
    </Panel>
  </Content>
  </UI>
  <UI Name=“TextRun”>
  <Properties>
    <TextRunData Name=“Data” TextRunData=“$Required”/>
    <code:BooleanChoice Name=“FragmentMouseFocus”/>
    <code:BooleanChoice Name=“FragmentKeyFocus”/>
    <code:BooleanChoice Name=“FragmentClicking”/>
  </Properties>
      <Scripts>
    <Script>
      if ([FragmentMouseFocus.Value])
    Renderer.Color = Color.Blue;
      else
    Renderer.Color = Data.Color;
    </Script>
    <Script>
    [DeclareTrigger(FragmentClicking.Value)]
    if (FragmentClicking.Value)
    {
      ColorFill.Scale = new Vector3(1.2,1.2,1.2);
      ColorFill.Rotation = new Rotation(2);
    }
    else
    {
      ColorFill.Scale = new Vector3(1.0,1.0,1.0);
      ColorFill.Rotation = new Rotation(0);
    }
    </Script>
  </Scripts>
  <Content>
    <ColorFill Name=“ColorFill” Content=“Transparent”
Layout=“HorizontalFlow”>
    <Animations>
      <Animation Type=“Scale” CenterPointPercent=“0.5, 0.5, 0”>
      <Keyframes>
        <ScaleKeyframe Time=“0.0” RelativeTo=“Current”/>
        <ScaleKeyframe Time=“0.1” RelativeTo=“Final”/>
      </Keyframes>
      </Animation>
      <Animation Type=“Rotate” CenterPointPercent=“0.5, 0.5, 0”>
      <Keyframes>
        <RotateKeyframe Time=“0.0” RelativeTo=“Current”/>
        <RotateKeyframe Time=“0.1” RelativeTo=“Final”/>
      </Keyframes>
      </Animation>
    </Animations>
    <Children>
      <TextRunRenderer Name=“Renderer” Data=“{Data}”/>
    </Children>
    </ColorFill>
  </Content>
  </UI>
</UIX>
```

Illustrated in the markup code above is a section of text content labeled by the CDATA tag. Within the text content are several text runs labeled by various tags that identify the text within the tags as text runs (e.g., the “<Artist> ” and “<Album>” tags). Of particular interest in this example is the text run “Tattle Tale” that is within the <Artist> tags (i.e., “<Artist>Tattle Tale</Artist>”). This text run corresponds to the central text in FIG. 4.

Further in the section of markup are a number of text effects that are to be applied to one or more identified text runs. One example of this code is the following:

```
<UI Name=“TextRun”>
  <Properties>
  <TextRunData Name=“Data” TextRunData=“$Required”/>
  <code:BooleanChoice Name=“FragmentMouseFocus”/>
  <code:BooleanChoice Name=“FragmentKeyFocus”/>
  <code:BooleanChoice Name=“FragmentClicking”/>
  </Properties>
  <Scripts>
  <Script>
    if ([FragmentMouseFocus.Value])
    Renderer.Color = Color.Blue;
    else
    Renderer.Color = Data.Color;
  </Script>
  <Script>
    [DeclareTrigger(FragmentClicking.Value)]
    if (FragmentClicking.Value)
    {
    ColorFill.Scale = new Vector3(1.2,1.2,1.2);
    ColorFill.Rotation = new Rotation(2);
    }
    else
    {
    ColorFill.Scale = new Vector3(1.0,1.0,1.0);
    ColorFill.Rotation = new Rotation(0);
    }
  </Script>
  </Scripts>
  <Content>
  <ColorFill Name=“ColorFill” Content=“Transparent”
Layout=“HorizontalFlow”>
    <Animations>
    <Animation Type=“Scale” CenterPointPercent=“0.5, 0.5, 0”>
      <Keyframes>
      <ScaleKeyframe Time=“0.0” RelativeTo=“Current”/>
      <ScaleKeyframe Time=“0.1” RelativeTo=“Final”/>
      </Keyframes>
    </Animation>
    <Animation Type=“Rotate” CenterPointPercent=“0.5, 0.5, 0”>
      <Keyframes>
      <RotateKeyframe Time=“0.0” RelativeTo=“Current”/>
      <RotateKeyframe Time=“0.1” RelativeTo=“Final”/>
      </Keyframes>
    </Animation>
    </Animations>
    <Children>
    <TextRunRenderer Name=“Renderer” Data=“{Data}”/>
    </Children>
    </ColorFill>
  </Content>
  </UI>
</UIX>
```

In the section of markup above, the “<UI name=‘textrun’>” tag identifies the section following the tag as including code for custom text effects that are to be applied to the identified text run(s). Following the tag are several sections of executable script that provide the text effects. In some embodiments, one or more sections of script that apply text effects are executed when the markup document is loaded by an application (e.g., a web browser) at the application's runtime. Additionally and/or alternatively, the script may be executed in response to user input, such as a mouse click on a text run and/or hovering a cursor over a text run. As illustrated in the markup, the scripts provide for effects such as changing text color, text scaling, and text rotation. In this example, the script provides a color change, scale change, and rotation for the text run identified in FIG. 4. The markup also includes a “textrunrenderer” element, which indicates that the identified text run(s) are to be rendered with the specified text effect(s). These particular text effects are illustrated for purposes of example only, and a wide variety of text effects may be implemented without departing from the spirit and scope of the claimed embodiments. To provide text effects for a text run, a user may select one or more preexisting text effects to be applied to a text run, and/or the user may provide code (e.g., one or more custom scripts) for the text effects.

As illustrated in the examples above, one or more embodiments enable a user to (1) identify one or more text runs in markup and, in line with the identified text run(s), (2) specify one or more custom text effects to be applied to the text run(s). Multiple different text runs or groups of text runs may each be identified with different text run tags, thus allowing each of the different text runs or groups of text runs to be rendered with one or more unique text effects.

Various techniques may be described herein in the general context of software or program modules. Generally, software includes routines, computer-executable instructions, programs, objects, components, data structures, and so forth that perform particular tasks or implement particular abstract data types. An implementation of these modules and techniques may be stored on or transmitted across some form of computer-readable media. Computer-readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

The above-described principles and techniques provide for identifying text and specifying text effects for the text. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented by one or more computing devices, the method comprising:
identifying, using a tag, a text run within text content that is in a markup document; and
specifying within the markup document a text effect to be applied to the text run, the text effect comprising executable code within the markup document, the executable code being configured to apply one or more graphical effects to the text run based at least in part on the tag.

2. A method as recited in claim 1, wherein the method is implemented by an application programming interface (API).

3. A method as recited in claim 1, wherein the text effect comprises script within the markup document.

4. A method as recited in claim 1, wherein at least one of the one or more graphical effects comprises text rotation.

5. A method as recited in claim 1, wherein at least one of the one or more graphical effects comprises text animation.

6. A method as recited in claim 1, wherein at least one of the one or more graphical effects comprises a bitmap effect.

7. A method as recited in claim 1, further comprising rendering the text run with the text effect.

8. A method as recited in claim 7, wherein the act of rendering occurs in response to the markup document being loaded by an application.

9. A method as recited in claim 7, wherein the act of rendering occurs in response to an interaction with the text run.

10. A method implemented by one or more computing devices, the method comprising:
loading a markup document that comprises text content and a text run within the text content, the text run being identified by a tag;
determining a text effect to be applied to the text run, the text effect being specified within the markup document and being associated with the text run based at least in part on the tag;
applying the text effect to the text run; and
rendering the text run with the text effect applied.

11. A method as recited in claim 10, wherein the method is implemented by an application programming interface (API).

12. A method as recited in claim 10, wherein the text content comprises a plurality of different text runs, each of the text runs being identified by a respective tag.

13. A method as recited in claim 10, wherein the text effect comprises executable script within the markup document.

14. A method as recited in claim 13, wherein the text effect utilizes the tag to identify the text run.

15. A method as recited in claim 10, wherein the text effect comprises one or more of text rotation, text animation, or a bitmap effect.

16. A system comprising:
one or more processors;
one or more computer-readable storage media;
computer-executable instructions stored on the computer-readable storage media and executable by the one or more processors to implement a method comprising:
marking a text run within text content with a tag; and
specifying a text effect, the text effect comprising script that is executable to apply a graphical effect to the text run based at least in part on the tag.

17. A system as recited in claim 16, wherein the method is implemented by an application programming interface (API).

18. A system as recited in claim 16, wherein the graphical effect comprises one or more of text animation, text scaling, or text rotation.

19. A system as recited in claim 16, wherein the text effect is configured to be applied to the text run in response to an interaction with the text run.

20. A system as recited in claim 16, wherein the method further comprises making the text run with the graphical effect applied available to be displayed.
